(19) United States
(12) Patent Application Publication
(10) Pub. No.: US 2020/0058060 A1
(43) Pub. Date: Feb. 20, 2020

(54) INFORMATION PROCESSING APPARATUS, ORDER TERMINAL APPARATUS, AND INFORMATION PROCESSING PROGRAM

(71) Applicant: TOSHIBA TEC KABUSHIKI KAISHA, Tokyo (JP)

(72) Inventor: Takashi YAMAMOTO, Numazu Shizuoka (JP)

(73) Assignee: TOSHIBA TEC KABUSHIKI KAISHA, Tokyo (JP)

(21) Appl. No.: 16/507,364

(22) Filed: Jul. 10, 2019

(30) Foreign Application Priority Data
Aug. 17, 2018 (JP) 2018-153510

(51) Int. Cl. G06Q 30/06; G06Q 20/20

(52) U.S. Cl. CPC G06Q 30/0631; G06Q 20/209; G06Q 30/0633; G06Q 20/203

(57) ABSTRACT

An information processing apparatus includes a determining section, a deciding section, and a notifying section. The determining section determines a designated article designated as a candidate of an order based on an operation by an operator. The deciding section decides, if the order of the designated article determined by the determining section cannot be received, another article as a recommended article. The notifying section notifies the recommended article decided by the deciding section to the operator together with a description about the recommended article.

### CROSS-REFERENCE TO RELATED APPLICATION

This application is based upon and claims the benefit of priority from Japanese Patent Application No. 2018-153510, filed in Aug. 17, 2018, the entire contents of which are incorporated herein by reference.

### FIELD

Embodiments described herein relate generally to an information processing apparatus, an order terminal apparatus, and an information processing program.

### BACKGROUND

It has already been known that, in an order system or the like that receives an order in a restaurant or the like, if a designated article cannot be ordered because of stockout or the like, display for recommending another article associated with the article is performed. However, if the display is a display of a list of names of recommended articles, a customer sometimes cannot recognize what kind of an article a recommended article is. In such a case, the customer needs to confirm the recommended article by viewing a menu table that describes contents of articles. Further, in this confirmation work, in some cases, the customer needs to find out or a store clerk needs to inform the customer about a description part of the recommended article in the menu table. Under such circumstances, it has been desired to be able to reduce labor and time for confirmation by a menu table about a recommended article while recommending an alternative article.

Related art is described in, for example, JP-A-2014-238713.

### DESCRIPTION OF THE DRAWINGS

FIG. 1 is a diagram illustrating a schematic configuration of a point-of-sale (POS) system and a main part circuit configuration of a handy terminal according to an embodiment;

FIG. 2 is a diagram illustrating the structure of a data record included in an attribute database;

FIG. 3 is a diagram illustrating the structure of a data record included in a management database;

FIG. 4 is a flowchart of information processing by a processor illustrated in FIG. 1;

FIG. 5 is a flowchart of the information processing;

FIG. 6 is a flowchart of the information processing; and

FIG. 7 is a diagram illustrating a recommendation screen as an example.

### DETAILED DESCRIPTION

An object of embodiments of the present disclosure is to provide an information processing apparatus, an information terminal apparatus, and an information processing program that can reduce labor and time for confirmation by a menu table about a recommended article while recommending an alternative article.

An information processing apparatus according to an embodiment includes a determining section, a deciding section, and a notifying section. The determining section determines a designated article designated as a candidate of an order by operation by an operator. The deciding section decides, if the order of the designated article determined by the determining section cannot be received, another article as a recommended article. The notifying section notifies the recommended article decided by the deciding section to the operator together with a description part in a menu table about the recommended article.

An example of an embodiment is explained below with reference to the drawings. In this embodiment, a POS system including a handy terminal functioning as an information processing apparatus is explained as an example.

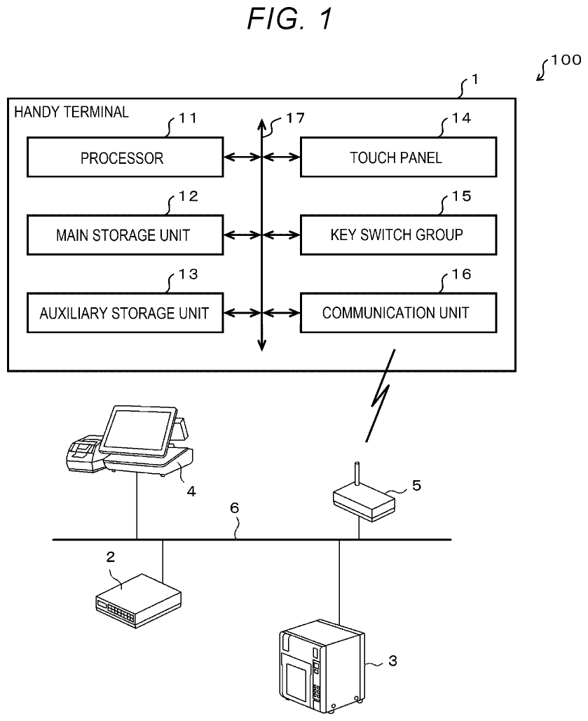

FIG. 1 is a diagram illustrating a schematic configuration of a POS system 100 and a main part circuit configuration of a handy terminal 1 according to this embodiment. The POS system 100 is usable in various facilities such as a restaurant that performs a service for providing commodities such as food and drink according to an order of a customer.

The POS system 100 includes a handy terminal 1, an order management apparatus 2, a slip printer 3, a POS terminal 4, a wireless router 5, and a communication network 6. One handy terminal 1, one slip printer 3, one POS terminal 4, and one wireless router 5 are illustrated in FIG. 1. However, the number of terminals 1, slip printers 3, POS terminals 4, and wireless routers 5 may vary. In most cases, a plurality of handy terminals 1 are included in the POS system 100. The POS system 100 is configured by enabling the handy terminal 1, the order management apparatus 2, the slip printer 3, and the POS terminal 4 to communicate with one another via the communication network 6. The handy terminal 1 is connected to the communication network 6 via the wireless router 5 by wireless communication with the wireless router 5. However, the handy terminal 1 may be directly connected to the communication network 6. Alternatively, the order management apparatus 2, the slip printer 3, and the POS terminal 4 may be connected to the communication network 6 via the wireless router 5 by wireless communication with the wireless router 5. Any two of the handy terminal 1, the order management apparatus 2, the slip printer 3, and the POS terminal 4 may communicate with each other via only the wireless router 5.

The handy terminal 1 is a form of an order terminal that receives operation for an order. The handy terminal 1 is carried and operated by a store clerk. The order management apparatus 2 manages the order received by the handy terminal 1.

The slip printer 3 is set in, for example, a customer service floor or a kitchen. The slip printer 3 set in the customer service floor prints an order slip for a customer. That is, the slip printer 3 set in the customer service floor is a so-called customer printer. The slip printer 3 set in the kitchen prints a cooking slip for a cook. That is, the slip printer 3 set in the kitchen is a so-called kitchen printer.

The POS terminal 4 is set in, for example, the customer service floor or a checkout counter. The POS terminal 4 performs information processing concerning various jobs such as guidance for a customer, order reception, serving, tray service, and accounting. The POS terminal 4 set in the customer service floor mainly executes the information processing concerning the guidance, the order reception, the serving, and the tray service. The POS terminal 4 set in the checkout counter further executes the information processing concerning the accounting. The POS terminal 4 may be specialized for a specific use by performing processing concerning only a part of the jobs.

The wireless router 5 enables, while performing wireless communication with an apparatus having a wireless communication function such as the handy terminal 1, the apparatus to communicate via the communication network 6. The wireless router 5 also enables, by mutually connecting a wireless line to the handy terminal 1 and a wireless line to another communication terminal, communication between the handy terminal 1 and the other communication terminal.

The communication network 6 transmits data exchanged among apparatuses having a communication function such as a handy terminal 1, the order management apparatus 2, the slip printer 3, and the POS terminal 4. As the communication network 6, a local area network (LAN) is typically used. However, as the communication network 6, besides the LAN, the Internet, a virtual private network (VPN), a public communication network, a mobile communication network, and the like can be used independently or used in combination as appropriate.

The handy terminal 1 includes a processor 11, a main storage unit 12, an auxiliary storage unit 13, a touch panel 14, a key switch group 15, a communication unit 16, and a transmission line 17.

The processor 11, the main storage unit 12, and the auxiliary storage unit 13 are connected by the transmission line 17 to configure a computer that executes information processing for realizing functions of the handy terminal 1. The processor 11 is a central part of the computer. The processor 11 executes information processing based on information processing programs such as an operating system, middleware, and application programs stored in the main storage unit 12 or the auxiliary storage unit 13.

The main storage unit 12 is equivalent to a main storage portion of the computer. The main storage unit 12 includes a nonvolatile memory region and a volatile memory region. The main storage unit 12 stores the information processing programs in the nonvolatile memory region. The main storage unit 12 sometimes stores, in the nonvolatile or volatile memory region, data necessary for the processor 11 in executing processing for controlling the sections. The main storage unit 12 uses the volatile memory region as a work area in which data is rewritten as appropriate by the processor 11.

The auxiliary storage unit 13 is equivalent to an auxiliary storage portion of the computer. The auxiliary storage unit 13 is, for example, an electric erasable programmable read-only memory (EEPROM), a hard disc drive (HDD), or a solid state drive (SSD). The auxiliary storage unit 13 saves data used by the processor 11 in performing various kinds of processing or data generated by the processing in the processor 11. The auxiliary storage unit 13 sometimes stores the information processing programs.

The touch panel 14 functions as an input device and a display device. The key switch group 15 includes a plurality of key switches to which articles set as order targets or various functions are allocated.

The communication unit 16 performs wireless communication between the communication unit 16 and the wireless router 5 and performs communication processing for the processor 11 to exchange various data with the order management apparatus 2 and the like. The transmission line 17 includes an address bus, a data bus, and a control signal line and transmits data and control signals exchanged among the connected sections.

As basic hardware of the handy terminal 1, basic hardware of an existing handy terminal of the same type can be used. In general, transfer of the handy terminal 1 is performed in a state in which an information processing program describing information processing explained below is stored in the main storage unit 12 or the auxiliary storage unit 13. However, hardware in a state in which the information processing program is not stored in the main storage unit 12 or the auxiliary storage unit 13 or a state in which an information processing program of another version of the same type is stored in the main storage unit 12 or the auxiliary storage unit 13 and the information processing program describing the information processing explained below may be individually transferred. The handy terminal 1 may be configured by writing the information processing program describing the information processing explained below in the main storage unit 12 or the auxiliary storage unit 13 according to operation by any operator. The transfer of the information processing program may be performed by recording the information processing program in a removable recording medium such as a magnetic disk, a magneto-optical disk, an optical disk, or a semiconductor memory or can be performed by communication via a network.

The operation of the POS system 100 configured as explained above is explained. Contents of various kinds of processing explained below are examples. For example, the order of a part of the processing can be changed, a part of the processing can be omitted, another kind of processing can be added as appropriate.

Sales management performed using the POS system 100 is performed in the same manner as sales management performed by an existing order system. As an example, a flow of the sales management is as explained below. The store clerk operates the handy terminal 1 in order to order a commodity found out by asking a customer. The handy terminal 1 transmits order data representing order content to the order management apparatus 2. The order management apparatus 2 creates, based on the order data received from the handy terminal 1, an order list representing content of the order and manages the order list. If order data concerning an additional order is sent from the handy terminal 1, the order management apparatus 2 updates the order list. Every time the order management apparatus 2 receives order data, the order management apparatus 2 instructs the same slip printer 3 or a different slip printer 3 to print a cooking slip or an order slip corresponding to the order data. The slip printer 3 prints the cooking slip and the order slip according to the instruction. A cook cooks a commodity according to the cooking slip. A store clerk in charge of customer service passes the order slip to the customer. The store clerk in charge of customer service serves the cooked commodity to a customer table. The POS terminal 4 acquires, according to operation by the store clerk or the customer, from the order management apparatus 2, an order list concerning the customer who is requesting accounting. The POS terminal 4 calculates, based on the acquired order list, a price for the provided commodity and settles the price.

In the handy terminal 1, for the operation explained above, the processor 11 executes information processing explained below. An attribute database and a management database are stored in the main storage unit 12 or the auxiliary storage unit 13 for the information processing by the processor 11 explained below.

The attribute database represents, about a plurality of items, attributes about respective articles of commodities set as targets of order reception in the handy terminal 1. The management database is a set of data for managing each of a plurality of items for which attributes are set in the attribute database.

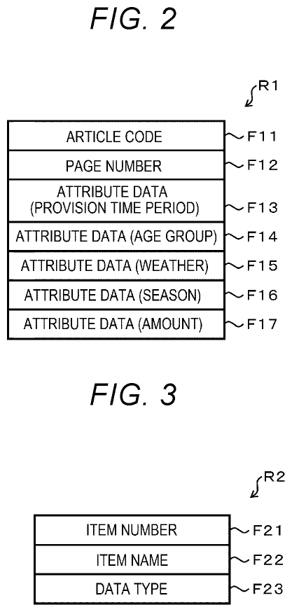

FIG. 2 is a diagram illustrating the structure of a data record included in the attribute database. The attribute database is a set of a plurality of data records R1 associated with each of articles set as targets of order reception. The data record R1 includes fields F11, F12 F13, F14, F15, F16, and F17.

In the field F11, data representing an article code for identifying an article associated with the field F11 is set. In the field F12, a page number of a page described in a menu table about an article associated with the field F12 is set. The menu table describes content about each of articles set as targets of order reception to enable the customer to visually confirm the content. The menu table may be a table of any form. In this embodiment, the menu table is a table of a book type including a plurality of pages. Predetermined five items are respectively allocated to the fields F13 to F17. Attributes about the allocated items are respectively set in the fields F13 to F17 concerning articles associated with the fields F13 to F17. In this embodiment, as an example, it is assumed that a provision time period, an age group, weather, a season, and an amount are respectively allocated to the fields F13 to F17 as items. What kinds of items are respectively allocated to the fields F13 to F17 may be optional and, for example, may be decided as appropriate by a designer, an administrator, or the like of the handy terminal 1. What kind of data is set as the attribute data may be optional and may be decided as appropriate by the designer, the administrator, or the like. The fields F13 to F17 may include, instead of or in addition to the fields, fields to which other items are allocated. The number of fields included in the data record R1 in order to set attribute data may be four or less. A plurality of fields included in the data record R1 in order to set attribute data are identified by ascending-order item numbers according to order in the data record of the fields. That is, in an example illustrated in FIGS. 2, 1 to 5 are respectively allocated as item numbers to the items respectively allocated to the fields F13 to F17.

If an article associated with the attribute data set in the field F13 is provided in a limited time period, the attribute data represents the time period when the article is provided. As the attribute data, for example, “morning”, “lunch”, or “dinner” is set. As the attribute data, data of another format such as “14:00 to 17:00” may be set.

The attribute data set in the field F14 represents an age group of customers set as a main target of an article associated with the attribute data. As the attribute data, for example, “thirties”, “forties”, or “fifties”, is set. As the attribute data, data of another format such as “thirty-one to thirty-five” or “thirty-six to forty” or “adult” or “child” may be set.

The attribute data set in the field F15 represents weather in which an article associated with the attribute data is more likely to be ordered. As the attribute data, for example, “fine”, “cloudy”, or “rain” is set. As the attribute data, data of another format such as “hot”, “cold”, or “high humidity” may be set.

The attribute data set in the field 16 represents a season in which an article associated with the attribute data is more likely to be ordered. As the attribute data, for example, “spring”, “summer”, “autumn”, or “winter” is set. As the attribute data, data of another format such as “March to June”, “July to October”, or “November to February” may be set.

The attribute data set in the field F17 represents an amount of an article associated with the attribute data. As the attribute data, for example, “1,000 yen”, “950 yen”, or “870 yen” is set. As the attribute data, data of another format such as “900 yen level” or “900 yen to 999 yen” may be set.

FIG. 3 is a diagram illustrating the structure of a data record included in the management database. The management database is a set of a plurality of data records R2 associated with respective items of the attribute data set in the attribute database. In this embodiment, the management database is a set of five data records R2 respectively associated with the five items. The data record R2 includes fields F21, F22, and F23.

In the field F21, data representing an item number for identifying an item associated with the field F21 is set. In the field F22, data representing an item name attached to an item associated with the field F22 is set. As the data, for example, “provision time period”, “age group”, “weather”, “season”, and “amount” are set.

In the field F23, data representing a data type of attribute data concerning an item associated with the field F23 is set. In this embodiment, if the attribute data concerning the associated with item is “age group” or “amount”, “numerical value” is set in the field F23. In this embodiment, if the attribute data concerning the associated item is “provision time period”, “weather”, or “season”, “text” is set in the field F23.

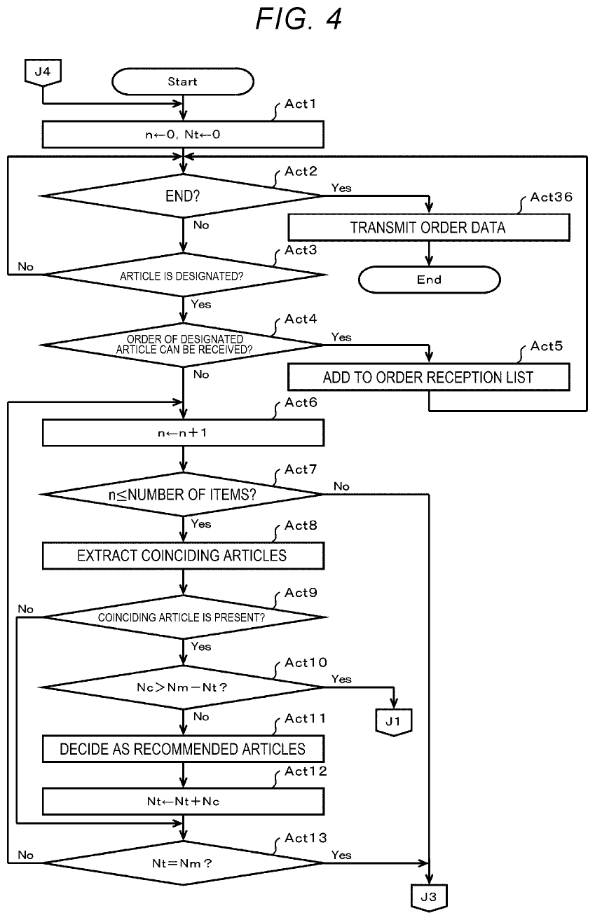

FIGS. 4, 5, and 6 are flowcharts of information processing by the processor 11. If predetermined operation for designating an order reception start is performed in the touch panel 14 or the key switch group 15, the processor 11 executes the information processing according to the information processing program stored in the main storage unit 12 or the auxiliary storage unit 13.

In Act 1, the processor 11 clears a variable n and a variable Nt respectively to 0. The variable n is a variable for managing an item number of an item focused for extraction of a recommended article explained below. The variable Nt represents a total number of articles determined as articles recommended as alternatives (hereinafter referred to as “recommended articles” of a designated article. Therefore, the variable n and the variable Nt are hereinafter referred to as item number n and total number Nt.

In Act 2, the processor 11 confirms whether designation of an article is ended. If the designation of an article is not ended, the processor 11 determines No and proceeds to Act 3. In Act 3, the processor 11 confirms whether an article to be ordered is designated. If an item is not designated, the processor 11 determines No and returns to Act 2. In this way, in Act 2 and Act 3, the processor 11 waits for article designation or an end of the article designation.

The store clerk asks the customer to find out an article that the customer is about to order. The store clerk performs operation for designating the article in the touch panel 14 or the key switch group 15. According to the operation, the processor 11 determines Yes in Act 3 and proceeds to Act 4. At this time, the processor 11 determines the article designated by the operation (hereinafter referred to as designated article). The processor 11 executes the information processing based on the information processing program in this way, whereby the computer including the processor 11 as the central part functions as a determining section that determines a designated article.

In Act 4, the processor 11 confirms whether an order of the designated article can be received. For example, if the designated article is not included in a stockout list stored in the main storage unit 12 or the auxiliary storage unit 13, the processor 11 determines that the order reception is possible. In this case, for example, the processor 11 starts another kind of information processing for interruption performed according to reception by the communication unit 16 of a stockout notification from the order management apparatus 2 and adds an article described in the stockout notification to the stockout list. If there is an order of an article that cannot be received because of some reason, the order management apparatus 2 sends a stockout notification about the article to all the handy terminals 1. The processor 11 may inquire the order management apparatus 2 about whether order reception is possible and perform the determination in Act 4 based on a replay from the order management apparatus 2.

If the order of the designated article is possible, the processor 11 determines Yes in Act 4 and proceeds to Act 5. In Act 5, the processor 11 adds the designated article in an order reception list. The order reception list is data indicating a list of article codes about articles for which order reception in the handy terminal 1 is completed. The order reception data is stored in the main storage unit 12 or the auxiliary storage unit 13. If an article is designated first, the processor 11 creates a new order reception list including an article code of the article and writes the order reception list in the main storage unit 12 or the auxiliary storage unit 13. Thereafter, the processor 11 returns to the waiting state in Act 2 and Act 3. Therefore, if the designation of an order-receivable article is repeated, the processor 11 repeatedly executes Act 5. If a new article is designated in a state in which the order reception list is already written in the main storage unit 12 or the auxiliary storage unit 13, in Act 5, the processor 11 updates the order reception list to add an article code of the article.

If the order reception of the designated article is not possible, the processor 11 determines No in Act 4 and proceeds to Act 6. In Act 6, the processor 11 increases the item number n by 1. In Act 7, the processor 11 confirms whether the item number n is equal to or smaller than the number of items of the attribute data in the attribute database. The number of items is five in the example illustrated in FIG. 2. If the item number n is equal to or smaller than the number of items, the processor 11 determines Yes and proceeds to Act 8. That is, if attribute data of an item with the item number n is present in the attribute database, the processor 11 proceeds to Act 8.

In Act 8, the processor 11 extracts all other articles, attribute data of which about the item with the item number n coincides with the attribute data of the designated article, (hereinafter referred to as coinciding articles). For example, the processor 11 selects, from the attribute database, the data record R1 in which an article code of the designated article is set in the field F11. If the item number n is 1, the processor 11 reads out attribute data set in the field F13 of the selected data record R1. Subsequently, the processor 11 selects, from the attribute database, all other data records R1 in which attribute data coinciding with the read-out attribute data is set in the fields F13. The processor 11 sets, as coinciding articles, articles identified by article codes set in the fields F11 of the selected data records R1. As a specific example, it is assumed that ten articles of an article A to an article J are present. It is assumed that, as a provision time period, which is an attribute of an item with an item number 1, “lunch” is set about an article A, an article B, and an article C and an attribute other than the “lunch” is set about an article D to an article J. If the designated article is the article A and the item number n is 1, the processor 11 extracts the article B and the article C as coinciding articles.

In Act 9, the processor 11 confirms whether at least one coinciding article is present. If at least one article is successfully extracted in Act 8, the processor 11 determines Yes and proceeds to Act 10. In Act 10, the processor 11 confirms whether a value of a variable Nc is larger than a value obtained by subtracting the total number Nt from a constant Nm. The processor 11 sets a value of the variable Nc to the number of coinciding articles extracted in Act 8 this time. A value of the constant Nm is a predetermined maximum number of recommended articles. Therefore, in the following explanation, the variable Nc and the constant Nm are referred to as extracted number Nc and maximum number Nm. A value of the maximum number Nm may be optional and may be decided as appropriate by, for example, the designer, the administrator, or the like of the handy terminal 1. In a specific example explained below, it is assumed that the maximum number Nm is five. A value of the total number Nt is 0 when the processor 11 executes Act 10 for the first time. Therefore, if executing Act 10 for the first time, the processor 11 confirms whether the extracted number Nc exceeds the maximum number Nm. If executing Act 10 for the second or subsequent times as explained below, the processor 11 confirms whether the extracted number Nc exceeds a difference between the maximum number Nm and the total number Nt. The difference between the maximum number Nm and the total number Nt is equivalent to the number of articles that can be added as recommended articles (hereinafter referred to as addable number). That is, the processor 11 confirms whether the extracted number Nc of coinciding articles in this time exceeds the addable number. If the extracted number Nc does not exceed the addable number, the processor 11 determines No and proceeds to Act 11.

In Act 11, the processor 11 decides all the coinciding articles extracted this time as recommended articles. In Act 12, the processor 11 updates the value of the total number Nt to a value obtained by adding the extracted number Nc to the existing value of the total number Nt. If finished updating the value of the total number Nt in Act 12, the processor 11 proceeds to Act 13. If no coinciding article is successfully extracted in Act 8, the processor 11 determines No in Act 9, skips Act 10 to Act 12, and proceeds to Act 13.

In Act 13, the processor 11 confirms whether the total number Nt coincides with the maximum number Nm. If the total number Nt does not reach the maximum number Nm, the processor 11 determines No and repeats Act 6 and subsequent acts. Consequently, the processor 11 sets second and subsequent items as targets and attempts to extract other articles, attribute data of the items of which coincides with attribute data of the designated article.

For example, it is assumed that, as an age group, which is an attribute of an item with an item number 2, “thirties” is set about the article A, the article D, and the article E and an attribute other than “thirties” is set about the article F to the article J. If the item number n is 2, the processor 11 extracts the article D and the article E as coinciding articles. Consequently, the extracted number Nc is two and, if the article B and the article C are already decided as the recommended articles as explained above, the addable number is 5−2=3. Therefore, the extracted number Nc does not exceed the addable number yet. Therefore, the processor 11 repeats Act 6 and subsequent acts once more.

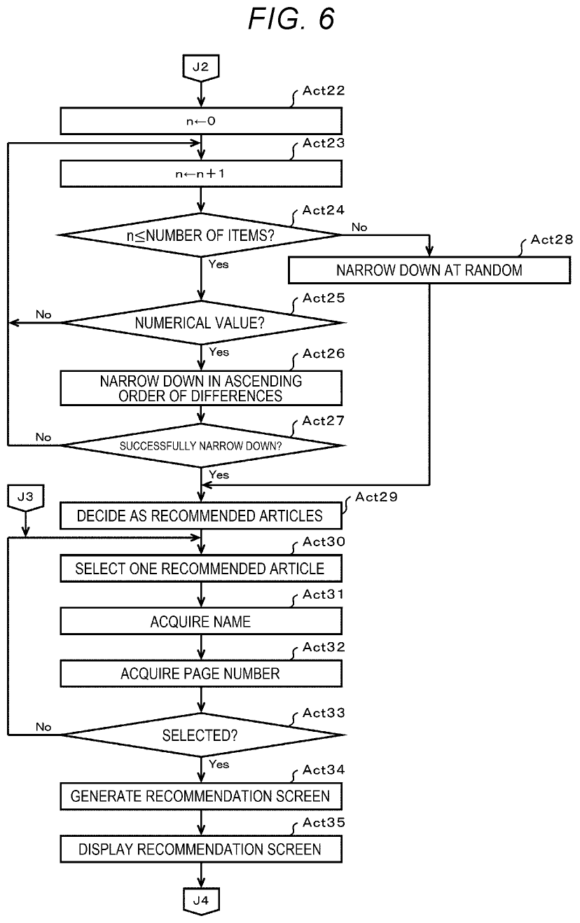

If the total number Nt coincides with the maximum number Nm, the processor 11 determines Yes in Act 13 and proceeds to Act 30 in FIG. 6. If the item number n becomes larger than the number of items included in the attribute database before the total number Nt reaches the maximum number Nm, the processor 11 determines No in Act 7 and proceeds to Act 30 in FIG. 6. That is, if the maximum number Nm of recommended articles are successfully decided or if the maximum number Nm of recommended articles are not successfully decided even if extraction of coinciding articles is attempted targeting all the items included in the attribute database, the processor 11 proceeds to Act 30. Processing in Act 30 and subsequent acts is explained below.

For example, it is assumed that as weather, which is an attribute of an item with an item number 3, “fine” is set about the article A and the article F and an attribute other than “fine” is set about the article F to the article J. If the item number n is 3, the processor 11 extracts the article F as a coinciding article. Consequently, the extracted number Nc is one. If the article B to the article E are already decided as recommended articles as recommended articles, the addable number is 5-4=1. Therefore, the extracted number Nc does not exceed the addable number yet. If the coinciding article is determined as a recommended article, the total number Nt increases to five and coincides with the maximum number Nm. Therefore, the processor 11 proceeds from Act 13 to Act 30 in FIG. 6.

As another specific example, it is assumed that, concerning the article A, “lunch”, “thirties”, “fine”, “autumn”, and “900 yen” are respectively set as the provision time period, the age group, the weather, the season, and the amount. On the other hand, it is assumed that “lunch” is set as the provision time period concerning the article B and “thirties” is set as the age group concerning the article C. Further, it is assumed that attributes of other items concerning the article B and the article C and attributes of all items concerning the article D to the article J are different from “lunch”, “thirties”, “fine”, “autumn”, and “900 yen”. In this case, the processor 11 decides only the article B and the article C as recommended articles. In this case, the processor 11 proceeds from Act 7 to Act 30 in FIG. 6.

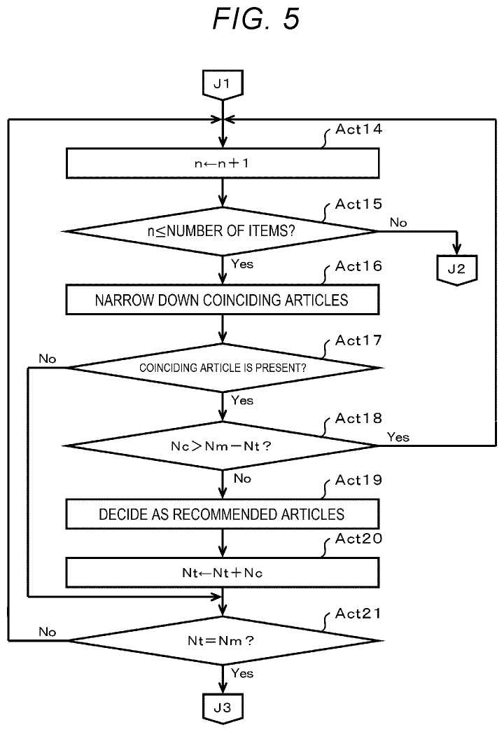

For example, it is assumed that, as the weather, which is the attribute of the item with the item number 3, “fine” is set about the article A, the article F, the article G, and the article H and an attribute other than “fine” is set about the article I and the article J. If the item number n is 3, the processor 11 extracts the article F, the article G, and the article H as coinciding articles. That is, the extracted number Nc is three. If the article B to the article E are already decided as the recommended articles as explained above, the addable number is 5−4=1. Therefore, the extracted number Nc exceeds the addable number. Therefore, in the processing of a loop of Act 6 to Act 13, if the extracted number Nc is larger than a value obtained by subtracting the total number Nt from the maximum number Nm, the processor 11 determines Yes in Act 10. In this case, the processor 11 proceeds to Act 14 in FIG. 5. That is, if the number of recommended articles exceeds the maximum number Nm because all articles extracted this time are determined as recommended articles, the processor 11 proceeds to Act 14 in FIG. 5.

In Act 15, the processor 11 increases the item number n by one. In Act 15, the processor 11 confirms whether the item number n is equal to or smaller than the number of items of the attribute data in the attribute database. If the item number n is equal to or smaller than the number of items, the processor 11 determines Yes and proceeds to Act 16. That is, if attribute data of an item with an item number n is present in the attribute database, the processor 11 proceeds to Act 16.

In Act 16, the processor 11 narrows down the coinciding articles extracted about the item with the item number n−1 to coinciding articles, attribute data of which about the item with the item number n coincides with attribute data of the designated article. In the specific example explained above, coinciding articles extracted about an item with an item number n−1 are the article F, the article G, and the article H. In this example, if, as a season, which is an attribute of an item with an item number 4, “autumn” is set about the article A and the article G and an attribute other than “autumn” is set about the article F and the article H, the processor 11 narrows down the coinciding articles to the article G. If, as the season, which is the attribute of the item with the item number 4, “autumn” is set about the article A, the article G, and the article H and an attribute other than “autumn” is set about the article F, the processor 11 narrows down the coinciding articles to the article G and the article H.

In Act 17, the processor 11 confirms whether at least one coinciding article is present. If at least one article is left by the narrow-down in Act 16, the processor 11 determines Yes and proceeds to Act 18. In Act 18, the processor 11 confirms whether the extracted number Nc is larger than the value obtained by subtracting the total number Nt from the maximum number Nm. The extracted number is the number of coinciding articles left by the narrow-down in Act 16. If the extracted number Nc does not exceed the addable number, the processor 11 determines No and proceeds to Act 19.

In Act 19, the processor 11 decides all the coinciding articles narrowed down this time as recommended articles. In the specific example, if the coinciding articles are narrowed down to the article G, the extracted number Nc is one. On the other hand, the value obtained by subtracting the total number Nt from the maximum number Nm is 5−4=1. Therefore, the processor 11 determines No in Act 18 and decides the article G as a recommended article.

In the specific example, if the coinciding articles are narrowed down to the article G and the article H, the extracted number Nc is two. On the other hand, the value obtained by subtracting the total number Nt from the maximum number Nm is 5−4=1. Therefore, the processor 11 determines Yes in Act 18. In this case, the processor 11 repeats Act 14 and subsequent acts. That is, the processor 11 attempts further narrow-down of the coinciding articles based on attribute data of lower-order items.

In Act 20, the processor 11 updates the value of the total number Nt to a value obtained by adding the extracted number Nc to the existing value of the total number Nt. If finishing updating the value of the total number Nt in Act 20, the processor 11 proceeds to Act 21. If no coinciding article is left by the narrow-down in Act 16, the processor 11 determines No in Act 17, skips Act 18 to Act 20, and proceeds to Act 21.

In Act 21, the processor 11 confirms whether the total number Nt coincides with the maximum number Nm. If the total number Nt does not reach the maximum number Nm, the processor 11 determines No and repeats Act 14 and subsequent acts. Consequently, the processor 11 attempts narrow-down based on attribute data of lower-order items and determination of recommended articles. If the total number Nt coincides with the maximum number Nm, the processor 11 determines Yes in Act 21 and proceeds to Act 30 in FIG. 6. Processing in Act 30 and subsequent acts is explained below.

In the execution of a loop of Act 14 to Act 21, if the item number n becomes larger than the number of items included in the attribute database before the total number Nt reaches the maximum number Nm, the processor 11 determines No in Act 15 and proceeds to Act 22 in FIG. 6. That is, if the maximum number Nm of recommended articles are not successfully determined even if narrow-down of the coinciding articles is attempted targeting all the items included in the attribute database, the processor 11 proceeds to Act 22 in FIG. 6.

In Act 22, the processor 11 clears the value of the item number n to 0. In Act 23, the processor 11 increases the item number n by 1. In Act 24, the processor 11 confirms whether the item number n is equal to or smaller than the number of items of the attribute data in the attribute database. If the item number n is equal to or smaller than the number of items, the processor 11 determines Yes and proceeds to Act 25. That is, if the attribute data of the item with the item number n is present in the attribute database, the processor 11 proceeds to Act 25.

In Act 25, the processor 11 confirms whether a data type of the attribute data about the item with the item number n is “numerical value”. Specifically, the processor 11 acquires the data record R2, the field F21 of which coincides with the item number n, from the management database. The processor 11 confirms whether data set in the field F23 of the acquired data record R2 represents “numerical value”. Specifically, data types of the provision time period, the weather, and the season, which are the attributes of the items with the item numbers 1, 3, and 4, are not “numerical value”. Therefore, if the item number is 1, 3, or 4, the processor 11 determines No and returns to Act 23. On the other hand, data types of the age group and the amount, which are the attributes of the items with the item numbers 2 and 5, are “numerical value”. Therefore, if the item number is 2 or 5, the processor 11 determines Yes and proceeds to Act 26.

In Act 26, the processor 11 extracts, out of the coinciding articles narrowed down so far, Nm-Nt coinciding articles in order from a coinciding article having the smallest absolute value of a difference of a numerical value indicated by the attribute data about the item with the item number n from a numerical value indicated by attribute data concerning a designated article about the same item.

It is assumed that, in the specific example, the processor 11 does not successfully narrow down one of the article G and the article H, which are the coinciding articles, in Act 16 and, as the age group, which is the attribute of the item with the item number 2, “thirties”, “forties”, and “fifties” are respectively set about the article A, the article G, and the article H. In this case, the processor 11 calculates “10” as the absolute value of “30-40” about the article G. The processor 11 calculates “20” as the absolute value of “30-50” about the article H. As a result, the processor 11 narrows down the coinciding articles to the article G.

In Act 27, the processor 11 confirms whether the processor 11 successfully narrows down the Nm-Nt coinciding articles in Act 26. For example, it is assumed that, separately from the specific example, as the age group, which is the attribute of the item with the item number 2, “thirties”, “forties”, and “twenties” are respectively set about the article A, the article G, and the article H. The processor 11 calculates “10” as the absolute value of “30-40” about the article G. The processor 11 calculates “10” as the absolute value of “30-20” about the article H. As a result, the processor 11 cannot narrow down the coinciding articles to one of the article G and the article H. If the processor 11 does not successfully narrow down the coinciding articles in this way, the processor 11 determines No in Act 27 and repeats Act 23 and subsequent acts. Consequently, the processor 11 attempts the narrow-down in Act 26 concerning a lower-order item, a data type of which is “numerical value”. If the processor 11 successfully narrows down the coinciding articles, the processor 11 determines Yes in Act 27 and proceeds to Act 29.

If the item number exceeds the number of items of the attribute data in the attribute database while the processor 11 does not succeed in the narrow-down in Act 26, the processor 11 determines No in Act 24 and proceeds to Act 28. That is, if the processor 11 cannot succeed in the narrow-down even if the processor 11 executes Act 25 to Act 27 targeting all the items, the processor 11 proceeds to Act 28.

In Act 28, the processor 11 narrows down the Nm-Nt coinciding articles at random out of the coinciding articles narrowed down so far. However, the processor 11 only has to narrow down the coinciding articles irrespective of attribute data according to predetermined rules. The rules may be optional. The processor 11 proceeds to Act 29. In Act 29, the processor 11 decides all the coinciding articles narrowed down this time as recommended articles. Thereafter, the processor 11 proceeds to Act 30. As explained above, the processor 11 sometimes proceeds to Act 30 from any one of Act 7 or Act 13 in FIG. 4 or Act 21 in FIG. 4. That is, if finishing deciding the recommended articles, the processor 11 proceeds to Act 30.

In Act 30, the processor 11 selects one of the recommended articles. In Act 31, the processor 11 acquires a name of the selected recommended article. Specifically, the processor 11 reads out the name of the recommended article from, for example, a commodity master stored in the auxiliary storage unit 13. The commodity master is a database that describes an article code, a name, a unit price, and the like concerning each of articles set as targets of order reception in the POS system 100. The commodity master may be stored in the order management apparatus 2, the POS terminal 4, a not-illustrated server apparatus, or the like. In this case, the processor 11 acquires the name of the recommended article from the order management apparatus 2, the POS terminal 4, or the not-illustrated server apparatus via the communication network 6. The processor 11 saves the acquired name in the main storage unit 12 or the auxiliary storage unit 13.

In Act 32, the processor 11 acquires a page number set in the field F12 of the data record R1 associated with the recommended article in the attribute database. The processor 11 saves the acquired page number in the main storage unit 12 or the auxiliary storage unit 13 in association with the name.

In Act 33, the processor 11 confirms whether all the recommended articles determined at a point in time when the processor 11 proceeds to Act 30 first are selected. If an unselected recommended article is present, the processor 11 determines No and repeats Act 30 and subsequent acts in the same manner as explained above. At this time, in Act 30, the processor 11 selects a recommended article not selected yet in the repetition of Act 30. In this way, the processor 11 acquires a name and a page number concerning each of the recommended articles by executing a loop of Act 30 to Act 33. If finishing acquiring names and page numbers concerning all the recommended articles, the processor 11 determines Yes in Act 33 and proceeds to Act 34.

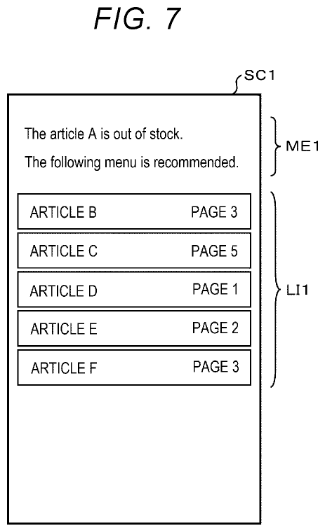

In Act 34, the processor 11 generates a recommendation screen. The recommendation screen is a screen showing a list of recommended articles. FIG. 7 is a diagram illustrating a recommendation screen SC1 as an example. The recommendation screen SC1 shows the article B to the article F as recommended articles as explained above. The recommendation screen SC1 shows a message ME1 and a list LI1. The message ME1 is a character message indicating that the article A, which is a designated article, is out of stock and articles shown in the list LI1 are recommended articles. The list LI1 shows a name of each of the recommended articles. The list LI1 shows, beside the name, a page number of a page of a menu table described about content of each of the recommended articles. The processor 11 shows the name and the page number, which are acquired about each of the recommended articles as explained above, side by side on the same row to thereby generate the list LI1. In Act 35, the processor 11 causes the touch panel 14 to display the recommendation screen generated as explained above. Thereafter, the processor 11 returns to Act 1 in FIG. 4.

If finishing designating, in the handy terminal 1, all the articles that the customer is about to order, the store clerk performs, on the touch panel 14 or the key switch group 15, predetermined operation for instructing to end the designation of the articles. According to the operation, the processor 11 determines Yes in Act 2 in FIG. 4 and proceeds to Act 36.

In Act 36, the processor 11 transmits order data including the order reception list to the order management apparatus 2. Consequently, the processor 11 requests the order management apparatus 2 to order the articles included in the order reception list. The processor 11 executes the information processing based on the information processing program in this way, whereby the computer including the processor 11 as the central part functions as a requesting section that performs the request. The processor 11 ends the information processing illustrated in FIGS. 4, 5, and 6.

The processor 11 executes the information processing based on the information processing program in this way, whereby the computer including the processor 11 as the central part functions as a deciding section that decide recommended articles. The computer including the processor 11 as the central part displays the recommendation screen on the touch panel 14 in Act 14, Act 23, or Act 32 to thereby notify the recommended articles to the operator together with a description part in the menu table about the recommended articles. The computer functions as a notifying section that perform such notification.

As explained above, with the handy terminal 1, if a designated commodity cannot be ordered, an alternative article can be recommended by the display of the recommendation screen. For each of the recommended articles, a page number of a page in which content of the article is described in the menu table is shown. Therefore, the store clerk informs the page number to the customer together with a name of a recommended menu, whereby the customer can easily confirm the recommended article with the menu table. The store clerk only has to inform the displayed information to the customer. Therefore, a burden due to this is small.

With the handy terminal 1, the recommended articles are decided, for each of the articles, according to a state of coincidence of attribute data respectively set concerning a plurality of items. Therefore, in a change of a menu that is changed only about a part of items, it is unnecessary to perform some correction of data concerning articles in which a change does not occur. It is possible to reduce labor and time for maintenance involved in the menu change.

With the handy terminal 1, the attribute data representing the attributes of the articles is used as setting data referred to in deciding recommended articles. Therefore, similarity of the attribute is reflected on the determination of the recommended articles. Consequently, it is possible to determine, as the recommended articles, articles more suitable to be recommended as alternatives.

With the handy terminal 1, if a large number of other articles, attribute data of which concerning items with higher priority levels coincides with attribute data of the designated articles, are present, the recommended articles are narrowed down according to a state of coincidence of attribute data concerning items with lower priority levels than the items. Therefore, the number of recommended articles does not become excessively large.

With the handy terminal 1, the number of recommended articles displayed on the recommendation screen is limited up to the maximum number Nm. Therefore, it is possible to facilitate selection of articles from the recommendation screen and effectively perform recommendation. That is, if the number of recommended articles displayed on the recommendation screen is too large, it is troublesome to select an article to be ordered out of the large number of recommended articles. Therefore, the recommendation screen is sometimes not referred to because of such a trouble. On the other hand, with the handy terminal 1, it is possible to avoid such a trouble and improve possibility of utilization of the recommendation screen.

Various modified implementations of this embodiment are possible as explained below. The processor 11 may decide the recommended articles with any method different from the method in the embodiment. For example, the processor 11 decides, as the recommended articles, articles associated with the articles in advance.

The processor 11 may acquire a page number included in data other than the attribute database such as the commodity master.

The processor 11 may generate the recommendation screen to show where in a plurality of areas formed by dividing one page of the menu table the recommended articles are displayed.

One or both of the attribute database and the management database may be stored in, for example, a storage device included in the order management apparatus 2 or a storage device provided on the outside of the handy terminal 1 such as a network drive connected to the communication network 6.

As the setting data, data not representing attributes of articles may be included instead of or in addition to the attribute data. For example, an identification code of a group optionally decided by the administrator may be used as the setting data.

The operator does not need to be the store clerk and may be, for example, a customer. That is, the handy terminal 1 may be an order terminal apparatus called table terminal or the like that is disposed in a customer table and receives an order by operation by the customer. Alternatively, the handy terminal 1 may be an order terminal apparatus of a type that is set, for example, near an entrance of a store and operated by the customer mainly when the customer enters the store. The order terminal apparatus of this type is sometimes an order terminal apparatus of a vending machine type including a settlement function. Further, the order terminal apparatus can also be realized as an information processing apparatus for information provision not having a function of receiving an order.

Notification of the recommended articles and the page number to the operator may be performed by any method different from the screen display such as output of a voice message.

Every time the processor 11 determines Yes in Act 4, the processor 11 may transmit order data for requesting order reception of designated articles at that time. In this case, the processor 11 does not perform Act 5 and Act 36.

A part or all of the functions realized by the processor 11 according to the information processing can also be realized by hardware that executes information processing not based on a computer program such as a logic circuit. Each of the functions explained above can also be realized by combining software control with the hardware such as the logic circuit.

The several embodiments are explained above. However, the embodiments are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. An information processing apparatus comprising:
a determining section configured to determine a designated article designated as a candidate of an order based on an operation by an operator;
a deciding section configured to decide, if the order of the designated article determined by the determining section cannot be received, another article as a recommended article; and
a notifying section configured to notify the recommended article decided by the deciding section to the operator together with a description about the recommended article.

2. The apparatus of claim 1, wherein the notifying section notifies, to the operator, as the description, a page number attached to a page on which the recommended article is described among a plurality of pages of a menu.

3. An order terminal apparatus comprising:
a processor configured to determine a requested article designated as a candidate of an order based on an operation by an operator;
a display configured to provide a notification to the operator regarding a recommended article together with a description about the recommended article in response to the requested article not being available; and
a communication unit configured to transmit a request to an order management apparatus to place an order of a designated article, the designated article being an article for which an order of which can be placed.

4. The order terminal apparatus of claim 3, wherein the description includes a page number regarding a page on which the recommended article is described among a plurality of pages of a menu.

5. The order terminal apparatus of claim 3, wherein the processor is configured to determine that the requested article is not available.

6. The order terminal apparatus of claim 5, wherein the processor is configured to determine that the requested article is not available based on data stored in a memory of the order terminal apparatus.

7. The order terminal apparatus of claim 5, wherein the processor is configured to determine that the requested article is not available based on data stored in a memory of an external device in wireless communication with the communication unit.

8. The order terminal apparatus of claim 3, wherein the communication unit is configured to receive an indication from an external device that the requested article is not available.

9. The order terminal apparatus of claim 3, wherein the processor is configured to determine the recommended article in response to the requested article not being available.

10. The order terminal apparatus of claim 9, wherein the processor is configured to determine the recommended article based on (i) the requested order and (ii) data stored in a memory of the order terminal apparatus.

11. The order terminal apparatus of claim 9, wherein the processor is configured to determine the recommended article based on (i) the requested article and (ii) data stored in a memory of an external device in wireless communication with the communication unit.

12. The order terminal apparatus of claim 3, wherein the communication unit is configured to receive an indication from an external device regarding the recommend article in response to the requested article not being available.

13. The order terminal apparatus of claim 3, wherein the order terminal apparatus is a portable device.

14. The order terminal apparatus of claim 3, wherein the order terminal apparatus is a stationary device.

15. A method comprising:
determining a requested article designated as a candidate of an order based on an operation by an operator;
deciding, if the requested article cis not available, another article as a recommended article; and
providing a notification to the operator regarding the recommended article together with a description about the recommended article.

16. The method of claim 15, further comprising determining, by an order terminal, that the requested article is not available.

17. The method of claim 15, further comprising determining, by an order management apparatus, that the requested article is not available.

18. The method of claim 15, further comprising determining, by an order terminal, the recommended article based on (i) the requested article and (ii) data stored in a memory of at least one of (a) the order terminal or (b) an external device.

19. The method of claim 15, further comprising determining, by an order management apparatus, the recommended article based on (i) the requested article and (ii) data stored in a memory of at least one of (a) the order management apparatus or (b) an external device.

20. The method of claim 19, further comprising transmitting an indication of the recommended article to an order terminal, wherein the order terminal provides the notification.
